(19) United States
(12) Patent Application Publication
(10) Pub. No.: US 2008/0182772 A1
(43) Pub. Date: Jul. 31, 2008

(54) NATURAL CLEANING SOLUTION ADAPTED FOR USE WITH BABY PRODUCTS

(76) Inventor: Noel Marie Hill, Fontana, CA (US)

Correspondence Address: MARC E. HANKIN, ESQ., 11414 THURSTON CIRCLE, LOS ANGELES, CA, 90049, US

(21) Appl. No.: 11/668,972

(22) Filed: Jan. 30, 2007

(51) Int. Cl. C11D 3/382

(52) U.S. Cl. 510/463

(57) ABSTRACT

Various embodiments of the invention are directed towards a natural cleaning solution for cleaning baby products such as baby bottles, pacifiers, baby toys, and the like. Various embodiments of the invention disclose a cleaning compound comprising, water, sodium bicarbonate, one or more plant based soaps, one or more citrus seed extracts, one or more products derived from alfalfa, one or more dried leaf herbal extracts, glycerin, and ethanol.

### FIELD OF INVENTION

Various embodiments of this invention relate, generally, to cleaning solutions and compounds; more particularly, to cleaning solutions and compounds comprised of natural ingredients that are adapted to clean baby products without soap or detergent type compounds.

### BACKGROUND

In baby feeding and rearing, it is crucial that all products that come into contact with the baby be meticulously cleaned. Because of the baby's relatively weak immune system and susceptibility to infection and disease, it is especially important that that objects coming into contact with the baby's mouth be cleaned and sterilized. With the plurality of items, such as baby bottles, pacifiers, and other such items being placed in the baby's mouth, germs and viruses can be easily transmitted to the baby if these items are not cleaned meticulously.

Thus, a plurality of systems and means have been developed for cleaning baby products. Many of the systems rely upon conventional soaps, detergents, and cleaners that are commonly used for cleaning adult eating implements.

Historically, soaps were formed from mixtures of sodium or potassium salts of fatty acids which can be derived from oils or fats by reacting them with an alkali (such as sodium or potassium hydroxide) in a process known as saponification. The fats are hydrolyzed by the base, yielding glycerol and crude soap. Historically, the alkali used was potassium made from the deliberate burning of vegetation such as bracken, or from wood ashes. Soap is commonly derived from either oils or fats. Sodium tallowate, a common ingredient in soaps, is typically derived from rendered beef fat. Soap can also be made from vegetable oils, such as olive oil. Soap made entirely from such oils, or nearly so, is called castile soap.

With the advent of modern mass productions systems, these ingredients are only commonly found in handmade soaps and the use of the word “soap” has become such a household name that even cleaning solutions for the body that don't have true “soap” in the ingredients are referred to as soap. Common soaps feature a plurality of undesirable chemicals, dyes, perfumes and other such items that are particularly undesirable for use with baby products.

Detergents, meanwhile, feature a plurality of ingredients such as surfactants, abrasives, pH modifying chemicals, acids, water softeners, oxidants, non-surfactants, enzymes, foaming chemicals, optical brighteners, artificial colors, perfumes, and other such compounds. It is undesirable, however, to bring such chemical compounds into contact with baby products, because trace amounts of the chemicals can come into contact with the baby's skin or other organs, or be ingested by the baby.

In an effort to reduce the quantity of chemicals and other such compounds required in certain cleaning devices, devices such as steam based bottle sterilizers have been developed in order to assist with the cleaning and sterilization of baby products. These devices possess certain advantages over the above compounds because they can operate with a minimum of chemicals and solutions in order to clean the baby products. Steam based sterilizers, for example, use steam in an enclosed space to sterilize baby products with only water. Such devices, however, are undesirable for a number of reasons. First, these devices are not portable because they often require electrical power and cannot be used outside of the home. Further, because they require steam generating systems, they can be relatively expensive to produce. Also, these devices cannot be used on products, such as furniture and cribs, that cannot be placed within the sterilization device.

Thus, there remains a long felt need in the art for a baby product cleaning solution or compound that does not require the use of undesirable chemicals and can be used without devices such as sterilizers and steamers.

### DESCRIPTION OF THE INVENTION

In the following description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the description is to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “baby product” is defined, with respect to this invention, to include any baby bottle, pacifier, sippy cups, flatware, baby and infant toys, baby baths, cribs, baby chairs, car seats, breast pumps and accessories, and other such items; “plant based soap” refers to any soap derived from plant products, including but not limited to: amole root, soap plant root, soaproot bulb, guaiac leaves, papaya leaves, quillaia bark, red campion root and leaves, atriplex root, sapindus fruit, soap pod fruit, mojave yucca root, soapwort root, our lord's candle root, wild gourd fruit, and other such plant soaps.

Various embodiments of the invention are directed towards overcoming the above shortcomings by disclosing a natural cleaning compound that may be used to clean baby products without the necessity of chemical compounds or other such undesirable additives.

Various embodiments of the invention comprise a compound for cleaning that includes: water, sodium bicarbonate, one or more plant based soaps, citrus seed extract, alfalfa, one or more dried leaf herbal extracts, glycerin from coconut oil, and ethanol.

Sodium bicarbonate is the chemical compound commonly referred to as baking soda. Sodium bicarbonate is useful as a cleaner and degreaser and lacks harmful chemicals. As is well known in the cooking arts, sodium bicarbonate is edible and commonly used as a leavening agent.

The use of plant based soaps within the context of the invention allows users to clean and degrease baby products without the need for additional chemical based detergents. Plant based soaps derived from plant products, include but are not limited to: amole root, soap plant root, soaproot bulb, guaiac leaves, papaya leaves, quillaia bark, red campion root and leaves, atriplex root, sapindus fruit, soap pod fruit, mojave yucca root, soapwort root, our lord's candle root, wild gourd fruit, and other such plant soaps.

Various embodiments of the invention further utilize one or more citrus seed extracts as part of the cleaning compounds. These citrus seed extracts include, but are not limited to: lemon seed extract, grapefruit seed extract, orange seed extract, tangerine seed extract, or other such citrus seed extracts from one or more of the following citrus fruits: bergamot orange, bitter orange, seville orange, blood orange, sour orange, desert lime, finger lime, grapefruit, ichang lemon, imperial lemon, kaffir lime, lemon, lime, sweet lemon, mandarin lime, mandarin orange, orange, orangelo, orangequat, persian lime, tahiti lime, rough lemon, sweet lime, tangelo, or tangerine.

Alfalfa (medicago sativa) or alfalfa extract is used within the context of various embodiments of the invention as a natural pH altering substance. Alfalfa may be incorporated into the compound through drying, grinding, juicing, extracting, compressing or any of the other various means known in the art for combining plant products with liquid compounds. These products can include one or more of the following: alfalfa extract, dried alfalfa, ground alfalfa, alfalfa juice, or alfalfa seed extract.

Various embodiments of the invention further utilize one or more dried-leaf herbal extracts. Dried-leaf herbal extracts, include, for example, cynara scolymus, perilla seed extract, astragalus membranaceus, rainforest graviola, and other such extracts that are useful in promoting strong immune and digestive operations.

The glycerin used within the context of various embodiments of the invention is derived from coconut oil. Glycerin is useful in the cleaning compound because it operates as one or more of a natural thickening agent, emollient, humectant, solvent, and/or lubricant.

Ethanol, as used within the context of various embodiments of the invention, is derived from corn. Ethanol is useful in the context of the invention because it is useful for denaturing their proteins and dissolving their lipids and is effective against most bacteria and fungi, and many viruses. Thus, it provides an effective, natural compound for cleansing and sterilizing products without the need for artificial cleansers and detergents.

In various embodiments of the invention, the solution is delivered as a baby wipe product. As is known in the art, baby wipes are often packaged and distributed with the cleansing solution on the surface of absorbent paper products, such as paper towels. The baby wipe embodiment allows the user to distribute the cleansing solution easily and eliminates much of the mess and inconvenience of using the solution. Various baby wipe dispensers are known in the art and remain within the contemplation of the invention.

In summary, various embodiments of the invention disclose a natural cleanser for baby products that cleans products without the need for chemical based cleansers and detergents. The description above describes the principles of the invention in general terms. It should be noted that, in the interests of conciseness, details of the invention that are commonly known in the art are not specifically described here. Also, the principles of the invention may be practiced with any of the various additional natural cleansing solutions known in the art. Any reference or non-reference to a particular system, chemical, or solution should not be interpreted as a limit on the scope of the invention.

What is claimed is:

1. A cleaning compound adapted for cleaning baby products, comprising:
water, sodium bicarbonate, one or more plant based soaps, one or more citrus seed extracts, one or more products derived from alfalfa, one or more dried leaf herbal extracts, glycerin, and ethanol.

2. A cleaning compound adapted for cleaning baby products according to claim 1, wherein said one or more plant based soaps are derived from one or more of the following plants and plant parts: amole root, soap plant root, soaproot bulb, guaiac leaves, papaya leaves, quillaia bark, red campion root and leaves, atriplex root, sapindus fruit, soap pod fruit, mojave yucca root, soapwort root, our lord's candle root, or wild gourd fruit.

3. A cleaning compound adapted for cleaning baby products according to claim 1, wherein said one or more citrus seed extracts are derived from one or more of the following citrus fruits: bergamot orange, bitter orange, seville orange, blood orange, sour orange, desert lime, finger lime, grapefruit, ichang lemon, imperial lemon, kaffir lime, lemon, lime, sweet lemon, mandarin lime, mandarin orange, orange, orangelo, orangequat, persian lime, tahiti lime, rough lemon, sweet lime, tangelo, or tangerine.

4. A cleaning compound adapted for cleaning baby products according to claim 1, wherein said one or more products derived from alfalfa are selected from the following products derived from alfalfa: alfalfa extract, dried alfalfa, ground alfalfa, alfalfa juice, or alfalfa seed extract.

5. A cleaning compound adapted for cleaning baby products according to claim 1, wherein said one or more dried leaf herbal extracts are derived from one or more of the following: cynara scolymus, perilla seed extract, astragalus membranaceus, rainforest graviola, and other such herbal extracts known in the art that are useful in promoting strong immune and digestive operations.

6. A cleaning compound adapted for cleaning baby products according to claim 1, wherein said glycerin is derived from coconut oil.

7. A cleaning compound adapted for cleaning baby products according to claim 1, wherein said ethanol is derived from corn.

8. A cleaning compound adapted for cleaning baby products according to claim 1, wherein said cleaning compound adapted for cleaning baby products is added to an absorbent paper product.

9. A cleaning compound adapted for cleaning baby products according to claim 8, wherein said absorbent paper product comprises a baby wipe.

10. A cleaning compound adapted for cleaning baby products, comprising:
water,
sodium bicarbonate,
one or more plant based soaps, wherein said one or more plant based soaps are derived from one or more of the following plants and plant parts: amole root, soap plant root, soaproot bulb, guaiac leaves, papaya leaves, quillaia bark, red campion root and leaves, atriplex root, sapindus fruit, soap pod fruit, mojave yucca root, soapwort root, our lord's candle root, or wild gourd fruit,
one or more citrus seed extracts, wherein said one or more citrus seed extracts are derived from one or more of the following citrus fruits: bergamot orange, bitter orange, seville orange, blood orange, sour orange, desert lime, finger lime, grapefruit, ichang lemon, imperial lemon, kaffir lime, lemon, lime, sweet lemon, mandarin lime, mandarin orange, orange, orangelo, orangequat, persian lime, tahiti lime, rough lemon, sweet lime, tangelo, or tangerine,
one or more products derived from alfalfa, wherein said one or more products derived from alfalfa are selected from the following products derived from alfalfa: alfalfa extract, dried alfalfa, ground alfalfa, alfalfa juice, or alfalfa seed extract,
one or more dried leaf herbal extracts, wherein said one or more dried leaf herbal extracts are derived from one or more of the following: cynara scolymus, perilla seed extract, astragalus membranaceus, rainforest graviola, and other such herbal extracts known in the art that are useful in promoting strong immune and digestive operations,
glycerin, said glycerin being derived from coconut oil, and
ethanol, said ethanol being derived from corn.

11. A paper based cleaning product adapted for cleaning baby products, comprising:
a paper based absorbent material containing a cleaning compound, said cleaning compound comprising:
water,
sodium bicarbonate,
one or more plant based soaps, wherein said one or more plant based soaps are derived from one or more of the following plants and plant parts: amole root, soap plant root, soaproot bulb, guaiac leaves, papaya leaves, quillaia bark, red campion root and leaves, atriplex root, sapindus fruit, soap pod fruit, mojave yucca root, soapwort root, our lord's candle root, or wild gourd fruit,
one or more citrus seed extracts, wherein said one or more citrus seed extracts are derived from one or more of the following citrus fruits: bergamot orange, bitter orange, seville orange, blood orange, sour orange, desert lime, finger lime, grapefruit, ichang lemon, imperial lemon, kaffir lime, lemon, lime, sweet lemon, mandarin lime, mandarin orange, orange, orangelo, orangequat, persian lime, tahiti lime, rough lemon, sweet lime, tangelo, or tangerine,
one or more products derived from alfalfa, wherein said one or more products derived from alfalfa are selected from the following products derived from alfalfa: alfalfa extract, dried alfalfa, ground alfalfa, alfalfa juice, or alfalfa seed extract,
one or more dried leaf herbal extracts, wherein said one or more dried leaf herbal extracts are derived from one or more of the following: cynara scolymus, perilla seed extract, astragalus membranaceus, rainforest graviola, and other such herbal extracts known in the art that are useful in promoting strong immune and digestive operations,
glycerin, said glycerin being derived from coconut oil, and
ethanol, said ethanol being derived from corn.
